(19) United States
(12) Patent Application Publication
(10) Pub. No.: US 2014/0022679 A1
(43) Pub. Date: Jan. 23, 2014

(54) Surge Protection Circuit

(71) Applicant: Ralink Technology Corp., Hsinchu County (TW)

(72) Inventors: Hsin-Hsien Li, Hsinchu County (TW); Yu-Lin Chu, Hsinchu County (TW); Li-Yu Chiu, Hsinchu County (TW)

(73) Assignee: Ralink Technology Corp., Hsinchu County (TW)

(21) Appl. No.: 14/044,863

(22) Filed: Oct. 2, 2013

Related U.S. Application Data
(63) Continuation of application No. 13/156,363, filed on Jun. 9, 2011, now abandoned.

(30) Foreign Application Priority Data
Apr. 7, 2011 (TW) 100112085

(51) Int. Cl. H02H 3/20

(52) U.S. Cl. CPC H02H 3/20
USPC 361/56; 361/119

(57) ABSTRACT

A surge protection circuit for a line driver of a communication system includes a positive output pad; a negative output pad; a transistor, comprising a first terminal, a second terminal and a third terminal, the first terminal coupled to the positive output pad, the second terminal coupled to the negative output pad; and a trigger circuit. The trigger circuit includes an inverter, comprising an input terminal and an output terminal, the output terminal coupled to the third terminal of the transistor; and a first RC delay circuit. The first RC delay circuit includes a resistor having a terminal coupled to an input terminal of the inverter, and another terminal coupled to a power supply; and a capacitor having a terminal coupled to the input terminal of the inverter and another terminal coupled to a ground. The transistor is within an integrated circuit.

### CROSS REFERENCE TO RELATED APPLICATIONS

This is a continuation application of U.S. application Ser. No. 13/156,363, filed Jun. 9, 2011, which is included in its entirety herein by reference.

### BACKGROUND OF THE INVENTION

1. Field of the Invention

The present invention relates to a surge protection circuit, and more particularly, to a surge protection circuit which can perform surge protection effectively and reduce cost.

2. Description of the Prior Art

In general, a communication system performing signal transmission via a transmission line, such as an asymmetric digital subscriber line (ADSL) system, a very high bitrate digital subscriber line (VDSL) system or a power line system (PLC) etc., maybe affected by a surge, e.g. the high power caused by a wavelet of an adjacent lightning, leading to damages. Because an output terminal of a line driver of the communication system is directly connected to the transmission line and affected by the surge first, the transmission line usually comprises a protection circuit for avoiding damages due to the surge.

However, a frequency of the surge is lower than a frequency of a conventional electrostatic discharge (ESD), i.e. different order, therefore the conventional ESD protection circuit cannot effectively perform surge protection, and the surge protection circuit needs to be set for performing surge protection. A corresponding surge test applies a differential mode surge signal on a positive output terminal and a negative output terminal of the surge protection circuit, and is different from the conventional ESD test applying ESD signal between a power supply and the output terminal or between a ground terminal and output terminal.

### SUMMARY OF THE INVENTION

It is therefore an objective of the present invention to provide a surge protection circuit to perform surge protection effectively and reduce cost.

The present invention discloses a surge protection circuit for a line driver of a communication system. The surge protection circuit includes a positive output pad; a negative output pad; a transistor, comprising a first terminal, a second terminal and a third terminal, the first terminal coupled to the positive output pad, the second terminal coupled to the negative output pad; and a trigger circuit. The trigger circuit includes an inverter, comprising an input terminal and an output terminal, the output terminal coupled to the third terminal of the transistor; and a first RC delay circuit. The first RC delay circuit includes a resistor having a terminal coupled to an input terminal of the inverter, and another terminal coupled to a power supply; and a capacitor having a terminal coupled to the input terminal of the inverter and another terminal coupled to a ground. The transistor is within an integrated circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of an electrostatic discharge protection circuit.

FIG. 1B is a schematic diagram of a surge protection circuit realized by Zener diodes.

FIG. 2 is a schematic diagram of a surge protection circuit according to an embodiment of the present invention.

### DETAILED DESCRIPTION

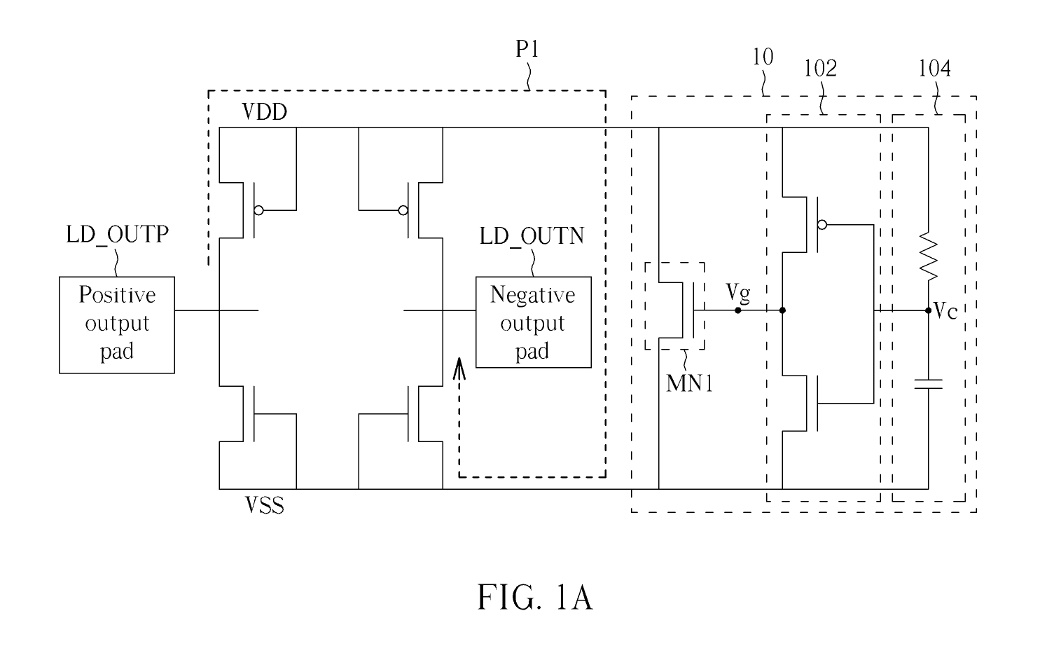

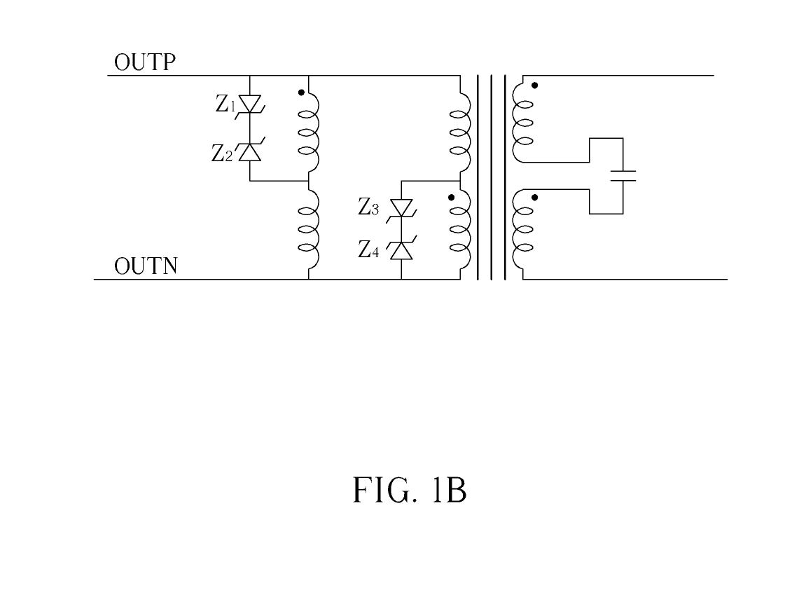

For example, please refer to FIG. 1A, which is a schematic diagram of an electrostatic discharge (ESD) protection circuit 10. The ESD protection circuit 10 has a function of power clamp, and comprises a transistor MN1, e.g. N-type metal oxide semiconductor (MOS) transistor, an inverter 102 and an RC circuit 104. In short, if an ESD signal is not applied, a capacitor voltage Vc is at a high voltage level and the inverter 102 can generate a voltage Vg of a low voltage level to a gate of the transistor MN1, such that the transistor MN1 is turned off; if the ESD signal is applied, the capacitor voltage Vc is switched to be a low voltage level and the inverter 102 can generate the voltage Vg of a high voltage level to the gate of the transistor MN1, so as to turn on the transistor MN1 and form a discharge path P1 between a positive output pad LDOUTP and a negative output pad LD_OUTN of the line driver as shown in FIG. LA. Since an RC time constant T1 of the RC circuit 104 has a same order as a period of the ESD signal, the discharge path P1 can be effectively conducted to discharge the ESD signal, so as to perform the ESD protection.

However, for a differential mode surge signal, a frequency of the differential mode surge signal is lower than that of the ESD signal, and therefore the ESD protection circuit 10 designed for discharging the ESD signal can not effectively discharge the differential mode surge signal for surge protection, i.e. because the period of the differential mode surge signal is greater than the RC time constant T1, the transistor MN1 may have turned off the discharge path P1 before the discharge path P1 completely discharges the differential mode surge signal. Besides, the lengthy discharge path P1 may also cause damages to other components. As a result, except the ESD protection circuit, a surge protection circuit is also needed to be set to perform surge protection.

For example, please refer to FIG. 1B, which is a schematic diagram of a surge protection circuit realized by Zener diodes Z1˜Z4. As shown in FIG. 1B, the Zener diodes Z1˜Z4 are set between a positive output terminal OUTP and a negative output terminal OUTN of the line driver on a circuit board to form a parallel path. The Zener diodes Z1˜Z4 breakdown to form a discharge path when receiving the differential mode surge signal, so as to avoid damages due to the differential mode surge signal. However, the structure is realized by Zener diodes and thus has higher cost.

As can be seen from the above, the ESD protection circuit 10 can not effectively perform surge protection, while the added surge protection circuit is realized by Zener diodes set on the circuit board and has higher cost. Thus, there is a need to improve.

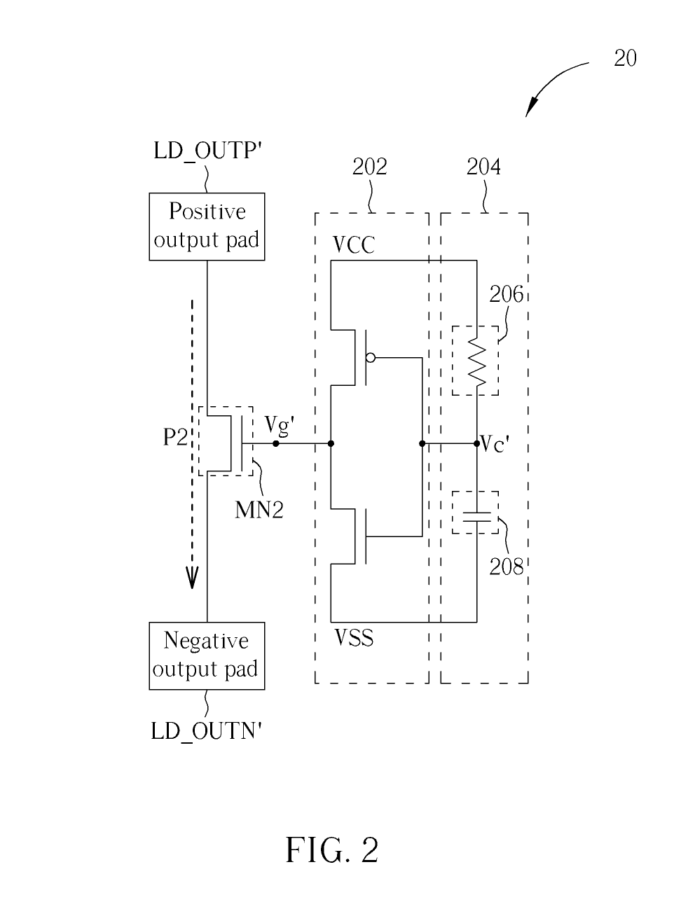

Please refer to FIG. 2, which is a schematic diagram of a surge protection circuit 20 according to an embodiment of the present invention. The surge protection circuit 20 is utilized in a line driver of a communication system for performing power clamp to a surge, and comprises a transistor MN2, e.g. N-type MOS transistor, an inverter 202 and an RC circuit 204, wherein the inverter 202 and the RC circuit 204 can be seen as a trigger circuit, and the transistor is within an integrated circuit. The detailed structure and connection manner of the surge protection circuit 20 are as shown in FIG. 2. The following is merely brief description. A drain of the transistor MN2 is coupled to a positive output pad LD_OUTP′ of the line driver, a source of the transistor MN2 is coupled to a negative output pad LD_OUTN′ of the line driver, a gate of the transistor MN2 is coupled to an output terminal of the inverter 202. The RC circuit 204 comprises a resistor 206 and a capacitor 208, and is cascaded between a power supply VCC and a ground terminal VSS, and the cross point of the resistor 206 and the capacitor 208 is coupled to an input terminal of the inverter 202. A RC time constant T2 of the RC circuit 204 is designed to be substantially equal to or greater than a period of the differential mode surge signal, e.g. the RC time constant T2 is designed to be substantially equal to or greater than 4 μs if the frequency of the surge signal is 1 MHz. As a result, when the differential mode surge signal is applied, the surge protection circuit 20 can effectively form a discharge path P2 between the positive output pad LD_OUTP′ and the negative output pad LD_OUTN′ without resulting damages to other components, so that there is no need to set up the diodes on the circuit board for surge protection, and thus reduce cost.

In detail, before applying the differential mode surge signal on the positive output pad LD_OUTP′ and the negative output pad LD_OUTN′, the capacitor voltage Vc′ of the capacitor 208 is at a high voltage level and the inverter 202 can generate a voltage Vg′ of a low voltage level to the gate of the transistor MN2, such that the transistor MN2 is turned off. After the differential mode surge signal is applied on the positive output pad LD_OUTP′ and the negative output pad LD_OUTN′, the capacitor voltage Vc′ is switched to be at a low voltage level and the inverter 202 can generate the voltage Vg′ of a high voltage level to the gate of the transistor MN2, such that the transistor MN2 is turned on to form the discharge path P2 between the positive output pad LD_OUTP′ and the negative output pad LD_OUTN of the line driver as shown in FIG. 2. Because the RC time constant T2 of the RC circuit 204 is designed to be substantially equal to or greater than the period of the differential mode surge signal, and the discharge path P2 can be effectively conducted to discharge the ESD signal for surge protection, the surge protection circuit 20 is different from the ESD protection circuit 10, where the transistor MN1 may have turned off the discharge path P1 before completely discharge the differential mode surge signal. Besides, the discharge path P2 directly discharge the differential mode surge signal from the positive output pad LD_OUTP′ toward the negative output pad LD_OUTN′, and not causing damages to other components. As a result, the surge protection circuit 20 can effectively form the discharge path P2 without causing damages to other components, therefore there is no need to set up the diodes on the circuit board to perform surge protection, and thus reduce cost.

Noticeably, the main spirit of the present invention is to add the surge protection circuit 20, whose structure is similar to that of the ESD protection circuit 10, between the positive output pad LD_OUTP′ and the negative output pad LD_OUTN′, and the RC time constant T2 of the RC circuit 204 is designed to be substantially equal to or greater than the period of the differential mode surge signal, so as to effectively form the direct discharge path P2 without causing damages to other components to perform surge protection. Therefore, there is no need to set up the diodes on the circuit board, and thus reduce cost. Those skilled in the art should make modifications or alterations accordingly. For example, applications of the present invention are not limited to the line driver of the communication system, such as an asymmetric digital subscriber line (ADSL) system, a very high bitrate digital subscriber line (VDSL) system or a power line system, as long as the line driver of the communication system performs signal transmission via a transmission line.

Besides, the transistor MN2 of the surge protection circuit 20 is realized by an N-type MOS transistor, and may also be realized by a P-type MOS transistor in practice, as long as the structures of the inverter 202 and the RC circuit 204 are modified correspondingly. The transistor MN2 can be any type of transistor and not limit to MOS transistor. Moreover, the present invention not only adds the surge protection circuit 20 to perform surge protection, but can also set up the ESD protection circuit 10 shown in FIG. 1A between the positive output pad LD_OUTP′ and the negative output pad LD_OUTN′, i.e. the RC time constant T1 of the ESD protection circuit 10 is less than the period of the differential mode surge signal, so as to achieve ESD protection.

As can be seen from the above, the ESD protection circuit can not perform surge protection effectively, and the added surge protection circuit realized via setting up the diodes on the circuit board has higher cost. In comparison, the present invention further adds the surge protection circuit 20, whose structure is similar to that of the conventional ESD protection circuit 10, between the positive output pad LD_OUTP′ and the negative output pad LD_OUTN′, and the RC time constant T2 of the RC circuit 204 is designed to be substantially equal to or greater than the period of the differential mode surge signal. Therefore, the direct discharge path P2 can be effectively formed without causing damages to other components for surge protection and there is no need to set up the diodes on the circuit board, and thus reduce cost.

To sum up, the present invention can form the direct discharge path without causing damages to other components for surge protection and there is no need to set up the diodes on the circuit board, and thus reduce cost.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A surge protection circuit for a line driver of a communication system, comprising:
a positive output pad;
a negative output pad;
a transistor, comprising a first terminal, a second terminal and a third terminal, the first terminal coupled to the positive output pad, the second terminal coupled to the negative output pad; and
a trigger circuit, coupled to the third terminal of the transistor, for turning on the transistor according to a signal applied on the positive output pad and the negative output pad;
wherein the transistor is within an integrated circuit.

2. The surge protection circuit of claim 1, wherein the trigger circuit, comprises:
an inverter, comprising an input terminal and an output terminal, the output terminal coupled to the third terminal of the transistor; and
a first RC delay circuit, comprising:
a resistor having a terminal coupled to an input terminal of the inverter, and another terminal coupled to a power supply; and
a capacitor having a terminal coupled to the input terminal of the inverter and another terminal coupled to a ground.

3. The surge protection circuit of claim 2, wherein a first RC time constant of the first RC circuit is substantially greater than or equal to a period of a differential mode surge signal.

4. The surge protection circuit of claim 3, wherein the transistor is turned off if the differential mode surge signal is not applied on the positive output pad and the negative output pad.

5. The surge protection circuit of claim 3, wherein the transistor is turned on to form a discharge path between the positive output pad and the negative output pad if the differential mode surge signal is applied on the positive output pad and the negative output pad.

6. The surge protection circuit of claim 3, wherein the communication system further comprises an electrostatic discharge (ESD) protection circuit, for performing electrostatic discharge protection, having a second RC time constant of a second RC circuit less than the period of the differential mode surge signal.

7. The surge protection circuit of claim 1, wherein the communication system is an asymmetric digital subscriber line (ADSL) system, a very high bitrate digital subscriber line (VDSL) system or a power line communication (PLC) system.
